(19) United States
(12) Patent Application Publication
(10) Pub. No.: US 2019/0172260 A1
(43) Pub. Date: Jun. 6, 2019

(54) SYSTEM FOR COMPOSING OR MODIFYING VIRTUAL REALITY SEQUENCES, METHOD OF COMPOSING AND SYSTEM FOR READING SAID SEQUENCES

(71) Applicant: ATOS INTEGRATION, Bezons (FR)

(72) Inventors: Gabriel MORIN, Maisons-Laffitte (FR); François DUJARDIN, Tours (FR)

(21) Appl. No.: 16/323,631

(22) PCT Filed: Aug. 8, 2017
(86) PCT No.: PCT/FR2017/052209

§ 371 Date: Feb. 6, 2019

(30) Foreign Application Priority Data
Aug. 9, 2016 (FR) 1657666

(51) Int. Cl. G06T 19/00

(52) U.S. Cl. CPC G06T 19/003

(57) ABSTRACT

The invention relates to a system for composing or modifying (1) a virtual reality experience sequence (10), said virtual reality experience sequence (10) comprising, on the one hand, a plurality of places (20) connected together, a connection between two places (20) being operated by a navigation node (320) and, on the other hand, media contents (30) connected to the places (20), a connection between a place (20) and a media content (30) being operated by media nodes (330), said system comprising:
a module (100) for composing a virtual reality experience sequence (20),
a configuration file or set of configuration files (300)
a device (350) including media files (360).

The invention relates to the field of virtual reality immersive experiences and to the fast and intuitive creation of customized sequences of virtual or augmented reality experience. The invention relates more particularly to a system for composing or modifying virtual reality sequences, a method enabling a composition or a fast modification of a virtual reality experience sequence implemented by said system and a system for reading the sequences composed thereby. The general objective is to allow the fast and easy integration of information so as to create a virtual reality experience sequence without programming effort and thus make it accessible to everyone.

### PRIOR ART

The virtual reality technique is developing rapidly and is affecting more and more areas such as architecture, communication, video games and learning. Virtual reality refers to a computer-designed environment that is able to simulate the physical presence of users in the real or imaginary mode. Virtual reality can be in the form of a single place with which the user can interact, or a set of places, so as to form a virtual reality sequence with which the user can interact.

Today, it is generally necessary, for the design and definition of a virtual reality sequence, to use in-depth knowledge in specialized software such as CATIA V5, Solidworks, Inventor, Sketchup, 3dsmax, Unreal Engine or Unity3D. These solutions make it possible to create complex sequences of virtual reality experience. Nevertheless, they require a lot of programming work by individuals who have pursued specialized programming studies. In addition, most virtual reality experiences, created by teams of programmers, are structurally stagnating. Thus, these solutions do not allow the creation of virtual reality sequences by individuals without programming knowledge. For example, the article “How to create a virtual reality application” published on Jun. 29, 2016 (URL:http://www.virtual-reality.com/create-virtual-reality-application) globally describes the virtual reality and the virtual reality experience design. It proposes in particular the use of the Unity3D software for carrying out the virtual reality experience but does not describe a system allowing a non-specialist to define all the elements of a virtual reality sequence.

This is confirmed by the manual “Scene Manager Manual” operating under Unity3D published on Jul. 19, 2016 on the Internet (ancientlightstudios.com/scenemanager/documentation/manual.pdf) or by the article “How to embed and play a video on an object in Unity3d and Jibe” published on Apr. 8, 2013 on the Internet (https://becunninciandfulloftricks.com/2013/04/08/how-to-embed-and-play-a-movie-on-an-object-in-unity3d-and-jibe/) which describe part of the programming commands necessary for the production of virtual reality experience sequences.

There are also in the state of the art solutions for viewing photos (e.g. Oculus Photos, available on GearVR, in which photos can be added by copying them on the SD card of the phone) and viewing videos (on the same principle, Oculus Video on GearVR). These applications do not allow customizing the environment in which these media are presented, nor do they allow creating a visit composed of several places between which one can navigate.

There are other solutions for creating virtual reality experiences which are relatively easy to implement, such as the solution described in “[DEMO] MRI Design Review System” (IEEE International Symposium on Mixed and Augmented Reality 2014, 10-12 Sep. 2014). Nevertheless, in order to provide easier design, these customizable virtual reality experiences are limited to a scene or a place.

However, the virtual reality is developing rapidly and the devices for providing access to this new media are more and more numerous. In order to promote its growth, it is necessary to have systems and associated methods allowing a user without in-depth programming knowledge to generate a virtual reality sequence that can meet his needs. Indeed, a user may wish to customize a virtual reality sequence so as to insert complementary experiences therein and this without having to re-encode the application managing this sequence. However, there is no solution able, without resorting to the programming, on the one hand, to progress in terms of structure according to the wishes of the author and, on the other hand, to integrate contents, containers or transitions coming from different origins and in particular from the resources of the author.

Thus, there is a need for new systems for composing virtual reality experience sequence capable of addressing the problems generated by the existing systems.

The invention aims at overcoming the drawbacks of the prior art. It enables in particular the implementation of a service for editing the virtual reality visit allowing a non-specialist to define all the elements of the visit (places, navigation links, searchable media and their positioning in each place) via an interface that does not require programming by the author.

In particular, the invention aims at proposing a system for composing a virtual reality sequence, said system being able to be implemented even in the absence of programming knowledge, being fast, simple and with a reduced number of steps. This system, based on a file or set of configuration files has the advantage of being able to handle the addition of experience modules, to improve the visit and to redefine the interaction rules proposed for the navigation and the media consultation without having to reprogram the entire product. Thus, it is also possible, from a basic sequence, to append all types of contents and this without programming knowledge.

The invention further aims at proposing a method for composing or modifying a virtual reality experience sequence allowing to change the sequence, to customize the environment in which the media are presented and in particular to create a visit composed of several places in which it is possible to navigate.

In addition, the invention proposes a reading system that has the advantage of being based on a lightweight, and therefore easily transferable, file or set of configuration files. Thus, it may be considered to transmit the virtual reality sequence in the form of a configuration file associated with media files on a fixed station, a tablet, a touch-screen phone or even a virtual reality headset.

Thus, the present invention provides a different approach from the conventional virtual reality approaches by proposing a very high level of customization, navigation and design.

### BRIEF DESCRIPTION OF THE INVENTION

For this purpose, the invention relates to a system for composing or modifying a virtual reality experience sequence, said virtual reality experience sequence comprising, on the one hand, a plurality of places connected together, a connection between two places being operated by a navigation node and, on the other hand, media contents connected to the places, a connection between a place and a media content being operated by media nodes, said system comprising:
a module for composing a virtual reality experience sequence,
a configuration file or set of configuration files comprising:
   at least one scene characterized by primary scene fields, said primary scene fields comprising a unique identifier of said scene and a means for access to an environment media file representing a place,
   at least one navigation node characterized by primary navigation fields, said primary navigation fields comprising a unique identifier of a departure scene, a unique identifier of an arrival scene, a position of the navigation node in the place of the departure scene according to a spherical coordinate system (O, x, y, z) and a transition rule,
   at least one media node characterized by primary media fields, said primary media fields comprising a unique identifier of the scene on which the media node depends, a position of the media node in the place of the scene comprising the media node according to a spherical coordinate system (O, x, y, z), an access path to a content media file and a control rule, and
a device including media files,
   said primary fields being associated with data elements defining a value of these primary fields, said module for composing the virtual reality experience sequence comprising a recording device equipped with rules enabling it to record the data elements in the configuration file or set of configuration files,
   said data elements defining at least partially the composed or modified virtual reality experience sequence.

According to other optional characteristics of the composition or modification system:
it comprises a display module. This module allows the author, during the modification, to quickly view the virtual reality experience sequence under preparation, without having to wait for the end of the composition or modification.
the navigation node(s) is/are further characterized by at least one secondary navigation field, said at least one secondary navigation field can be selected from:
   a unique identifier of the navigation node,
   a text, giving information on the navigation node, and
   a means for access to data on the arrival view;
      These secondary fields make it possible in particular to better characterize the navigation nodes and to create an experience more quickly.
the media node(s) is/are further characterized by at least one secondary media field, said secondary media field can be selected from:
   a unique identifier of the media node,
   a distance value, and
   a value for controlling time elapsing before execution of the media.
      These secondary fields make it possible in particular to better characterize the media nodes so as to add parameterization possibilities for the author and create a more immersive experience.
the data element of the rule for the control of at least one media node is selected from a slide show or a content grid.
the data element of the rule for the transition of at least one navigation node is selected from a section, a fade, a flap, a curtain, an animated transition or a transition including the playback of a video.
the size of the configuration file(s) is smaller than 200 kilobytes. One of the advantages of the invention is to be based on file systems which are, on the one hand, easy to modify and, on the other hand, lightweight and which require only few resources.
it comprises a set of configuration files, of which at least one file is an organizer configuration file comprising a list of the set of configuration files required for the customization of the virtual reality experience sequence. This facilitates the modification of large virtual reality experience sequences and gives the possibility to many authors to simultaneously modify the sequence.

According to another aspect, the invention relates to a method for composing or modifying a virtual reality experience sequence implemented by the system described above, said virtual reality experience sequence comprising, on the one hand, places connected together, a connection between two places being operated by a navigation node and, on the other hand, media contents connected to the places, a connection between a place and a media content being operated by media nodes, said method comprising:
a step of creating a connection, in a module for composing a virtual reality experience sequence, between a control device capable of interacting with an author and a recording device,
a step of loading by the recording device, a file or set of configuration files, said file or set of configuration files comprising:
   at least one scene characterized by primary scene fields, said primary scene fields comprising a unique identifier of said scene and a means for access to an environment media file representing a place,
   at least one navigation node characterized by primary navigation fields, said primary navigation fields comprising a unique identifier of a departure scene, a unique identifier of an arrival scene, a position of the navigation node in the place of the departure scene according to a spherical coordinate system (O, x, y, z) and a transition rule, and
   at least one media node characterized by primary media fields, said primary media fields comprising a unique identifier of the scene on which the media node depends, a position of the media node in the place of the scene comprising the media node according to a spherical coordinate system (O, x, y, z), an access path to a content media file and a control rule,
      said primary fields can be associated with data elements defining the value of these primary fields,
a step of displaying, by a display module, a creation interface configured to receive and display information from the module for composing the virtual reality experience sequence,
a step of creating, by the device for recording the virtual reality experience sequence, at least one data element associated with a primary scene, navigation and/or media marker, the data element associated with a primary marker allowing to at least partially define the virtual reality experience sequence, and
a step of recording said data element in the file or set of configuration files, by the recording device.

According to another aspect, the invention relates to a system for reading a virtual reality experience that can be obtained by the method described above, comprising a device for displaying a virtual reality experience sequence, said virtual reality experience comprising, on the one hand, places connected together, a connection between two places being operated by a navigation node and, on the other hand, media content connected to the places, a connection between a place and a media content being operated by media nodes, said device comprising:
a module for reading a virtual reality experience,
a display module,
a configuration file or set of configuration files comprising:
   at least one scene characterized by primary scene fields, said primary scene fields comprising a unique identifier of said scene and a means for access to an environment media file representing a place,
   at least one navigation node characterized by primary navigation fields, said primary navigation fields comprising a unique identifier of a departure scene, a unique identifier of an arrival scene, a position of the navigation node in the place of the departure scene according to a spherical coordinate system (O, x, y, z) and a transition rule, and
   at least one media node characterized by primary media fields, said primary media fields comprising a unique identifier of the scene on which the media node depends, a position of the media node in the place of the scene comprising the media node according to a spherical coordinate system (O, x, y, z), an access path to a content media file and a control rule,
a device including a set of media files,
   said primary fields being associated with data elements defining the value of these primary fields,
   said module for reading the virtual reality experience sequence comprising a means for access to data elements, a device for acquiring and processing data element, and a module for transmission to the module for displaying the virtual reality sequence.

According to other optional characteristics of the system for reading a virtual reality experience:
the reading system comprises a user identification module of the system for reading the virtual reality experience sequence capable of authorizing the multi-user reading of the virtual reality experience sequence. This allows multiple users to visit the same virtual reality experience sequence at the same time. In this case, the system can be configured such that a user, acting as a guide, has autorisations for determining the scene viewed by each of the users and configured to possibly force a user to change the scene so that the reading of the virtual reality experience sequence is done in a coordinated manner between all the users.
it is configured such that the actions, available to the users of the reading system, are represented by floating visual elements in a place that the user is visiting, said visual elements being placed in the place, based on the information contained in the file or set of configuration files. The visual elements are called floating elements because they are generally anchored in a 3D environment.
it is configured such that, when the user's gaze is close to a node, a cursor appears to help him to fix the point in question accurately. The fact that the user is informed of the existence of a node only when his gaze is close allows proposing a more immersive experience.
it is configured such that, when the user's gaze is close to a node, a time indicator appears to indicate to the user the imminence of the triggering of the action. The presence of a time indicator allows the user to cancel the access to a node by changing the position of his gaze, for example by positioning his gaze at a distance from the node (e.g. at a distance representing more than 10% of the length of the field of view).
it is configured such that a pointer representing the position of the user's gaze is visible only when the pointer is at a distance from the nearest object representing less than 10% of the length of the field of view.
it includes a module for displaying on a mobile device, said display module being able to display at least one recommended route.

Other advantages and features of the invention will appear upon reading the following description given by way of illustrative and non-limiting example, with reference to the appended figures which represent:

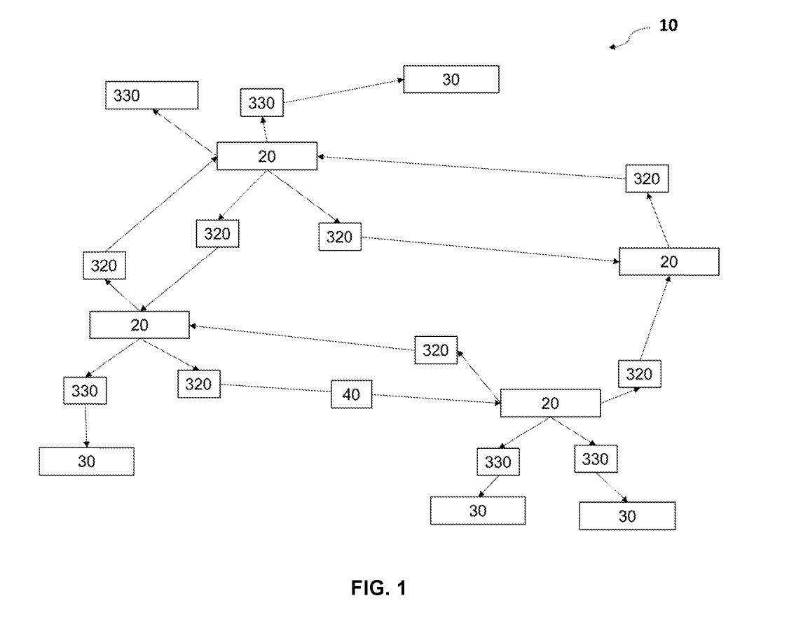

FIG. 1 represents the dependency graph of a virtual reality experience sequence according to the invention.

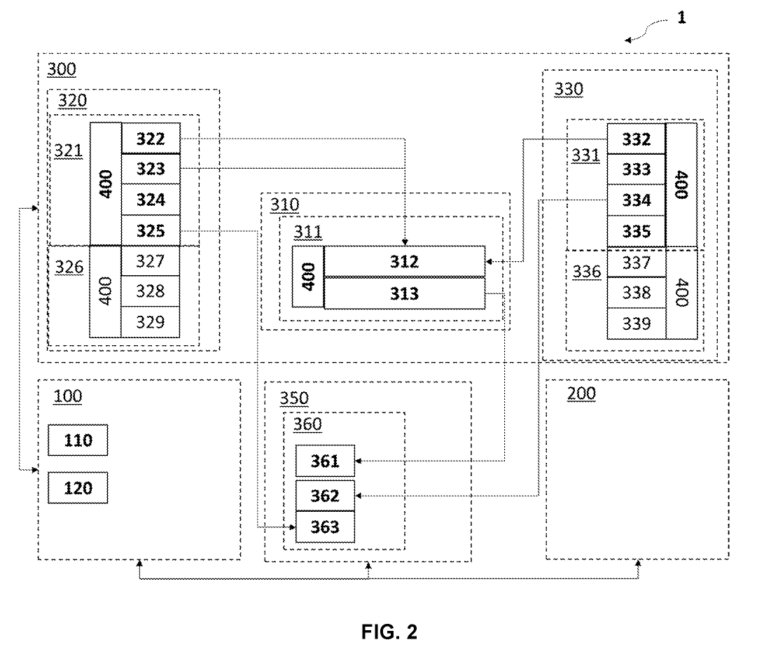

FIG. 2 represents an implementation diagram of the system for composing or modifying a virtual reality experience sequence according to the invention.

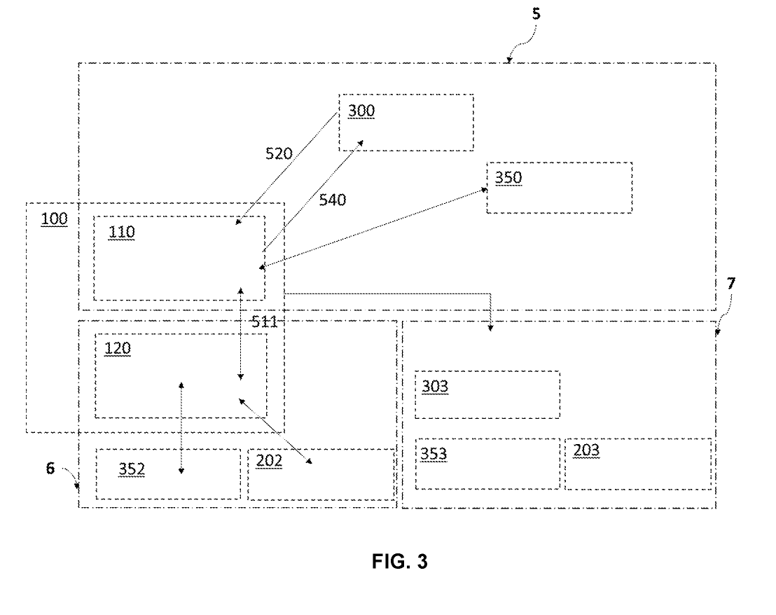

FIG. 3 represents the diagram of a system for composing or modifying a virtual reality experience sequence according to the invention integrated in a larger system, such as an information system of the customer relationship management type or an enterprise resource planning, manipulated through a cloud configuration, parameterization and distribution portal.

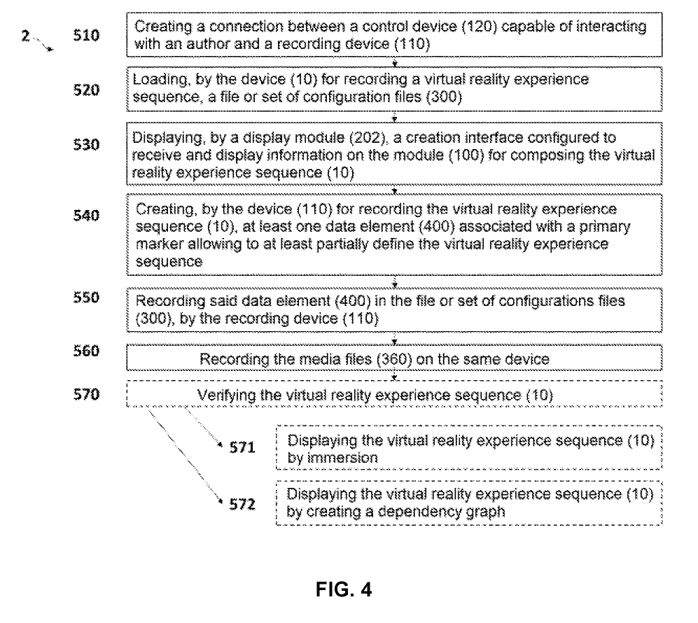

FIG. 4 represents a step sequencing constituting a variant of the composition method according to the invention.

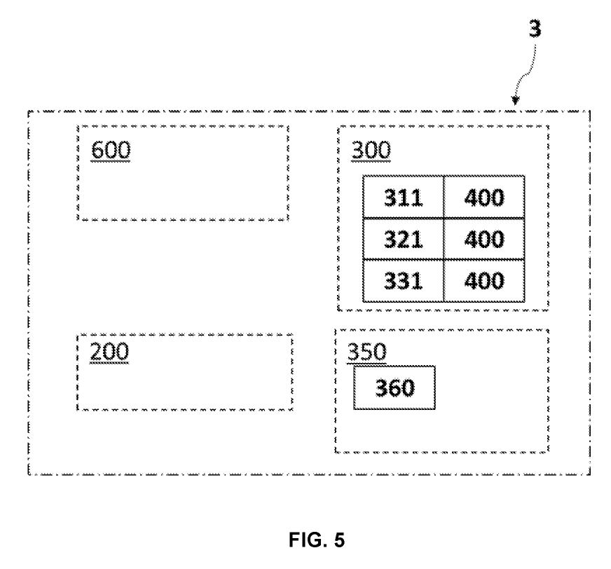

FIG. 5 represents a diagram of implementation of the system for reading a virtual reality experience sequence according to the invention.

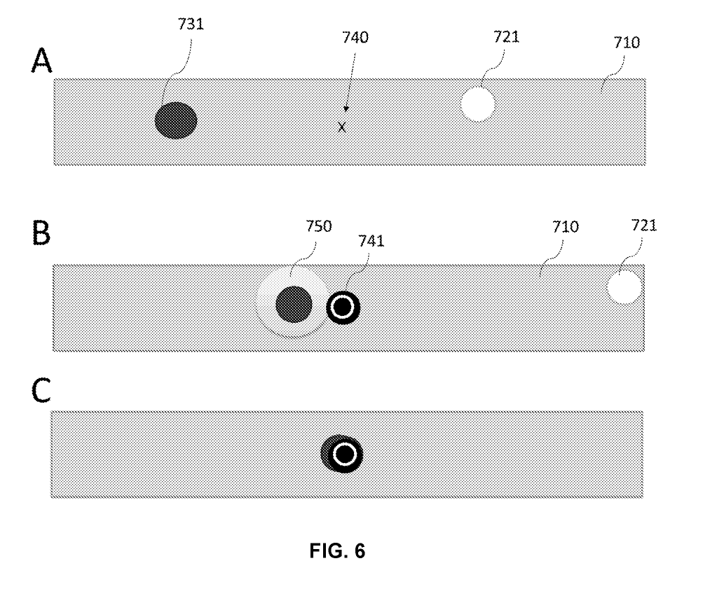

FIG. 6 represents the field of view of the user when he does not point his gaze (represented by “X”), and therefore the center of vision, in proximity to a node (A); when he points his gaze in proximity to a node (B) and when a node has been validated by a prolonged gaze of the user (C).

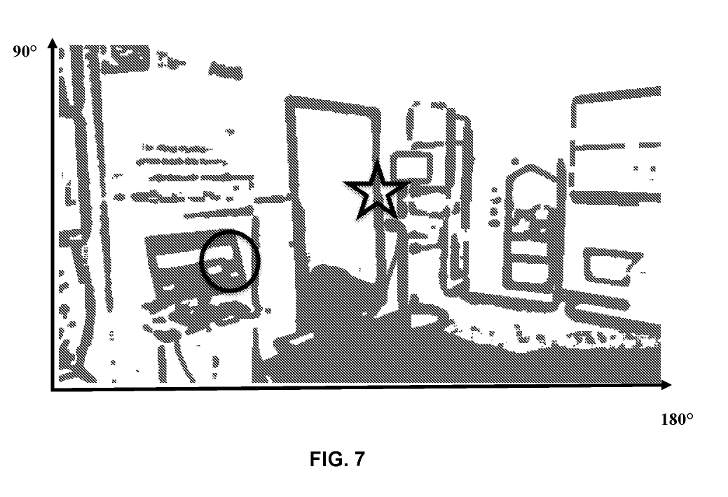

FIG. 7 represents a schematized view of a place comprising a door associated with a navigation node represented by a star (coordinates: 80°, 50°, 0°) and a computer screen associated with a media node represented by a circle (coordinates: 40°, 30°, 0°) as well as a spherical coordinate system.

### DESCRIPTION OF THE INVENTION

The expression “virtual reality experience sequence” in the meaning of the invention corresponds to a computer-designed environment that is able to simulate the physical presence of users in the real or imaginary mode. The environment is in the form of a set of places with which the user can interact.

By “author” is meant a person using the device or the method according to the invention to create or modify a virtual reality experience sequence and by “user” a person using the device or the method according to the invention to experience/use a virtual reality experience sequence.

By “access 313 to a media file” is meant the information required for access to a media file on a local storage medium, or by downloading or streaming it, from a remote storage, via a web protocol or an access to a database. It is usually an access path to the media file possibly preceded by an access protocol (such as http://, file://).

By “configuration file” within the meaning of the invention, is meant a file comprising the information required for the design of a virtual reality experience sequence. The file is accessible to the reading and composition modules in order to design the virtual reality experience sequence.

In the following description, by “mobile device” is meant a device that can be easily moved and used to view a virtual reality experience sequence. Generally it weighs less than 2 kilograms, preferably less than one kilogram and even more preferably less than 500 grams. For example, it can be selected from a laptop computer, a mobile phone, a tablet or an autonomous or wired virtual reality headset.

In the following description, by “dependence graph” is meant a schematic representation of a virtual reality sequence for viewing the interactions between the places and between the places and contents.

In the following description, by “navigation node” is meant an element indicating the point of passage from one point to another in a use scenario and by “media node” an element indicating the presence of a media defined at this place. These nodes may take the form of data and/or instructions that can be operated by the composition module according to the invention.

In the following description, the same references are used to designate the same elements.

The system according to the invention makes it possible to make a composition or modification of a virtual reality experience sequence and advantageously a customized virtual reality experience sequence without the need for the author to have encoding knowledge.

FIG. 1 schematizes a virtual reality experience sequence 10 according to the invention. This sequence comprises, on the one hand, places 20 connected together, a connection between two places 20 being operated by a navigation node 320 and, on the other hand, media content 30 connected to places 20, a connection between a place 20 and media content 30 being operated by media nodes 330.

The places 20 can be representations of real or imaginary places by 360 or 360 stereo 2D, 3D panoramic images, or 3D modeling of places. Preferably, the places 20 are representations of real places by 360 or 360 stereo 2D, 3D panoramic images or 3D modeling of places. The places are connected together by navigation nodes 320 and a user experiencing a virtual reality experience sequence 10 has the possibility to navigate between different places 20 by interacting with navigation nodes 320. A place 20 may be connected to several other places 20. Generally, except for the initial place 21, the places comprise at least one navigational node 320 enabling to return to the previous place 20. Thus, preferably in a virtual reality experience sequence 10 according to the invention, each place 20 comprises at least one navigation node 320. In addition, a virtual reality experience sequence 10 according to the invention generally comprises at least two places 20, preferably at least four places 20 and even more preferably at least six places 20. Preferably, each place 20 is represented by a 360 stereo image or a 3D modeled scene.

The places 20 may also comprise media nodes 330. These media nodes 330, once activated by a user, provide access at least to one media content 30. The media content 30 may be photos, slide shows, videos, sound elements such as the voice or a surround sound. Preferably the media content 30 are photos or videos.

Preferably, the virtual reality experience sequence 10 is representative of a real place and can be compared to a visit.

FIG. 2 schematizes an example of a system 1 for composing or modifying a virtual reality experience sequence 10 according to the invention. The system makes it possible to navigate from virtual areas (scenes, panoramas, etc.) to contents, from virtual areas to virtual areas and from contents to contents, each content can become a container, and vice versa. Indeed, when a media node 330 contains several media, the user can consult them for example in order (e.g. by means of a slide show including “previous” and “next” functions), or by means of a grid of selectable thumbnail images. Specifically, places 20 can also be navigable in the form of a slide show through navigation nodes 320.

The composition or modification system 1 according to the invention comprises:
a module 100 for composing a virtual reality experience sequence 20,
a configuration file or set of configuration files 300, including at least one scene 310, at least one navigation node 320 and at least one media node 330 and
a display module 200
a device 350 including media files 360.

The module 100 for composing the virtual reality experience sequence 20 includes a recording device 110 which is equipped with a rule allowing it to record, in the file or set of configuration files 300, the data elements 400 defining the values of primary and/or secondary fields and to have access thereto.

As shown in FIG. 2, the composition module 100 is capable of interacting with the file or set of configuration files 300, the media device 350 and a display module 200. The composition module 100 may in particular receive data from these different modules and transmit data thereto.

In addition, this composition module 100 may also comprise a control device 120, the latter being able to receive the instructions from an author and can be physically separate from the recording module 110.

In one embodiment, the recording module 110 comprises an application 111 that can be encoded in the Unity programming language and defining in particular the rules enabling it to record, in the file or set of configuration files 300, the data elements 400 defining the primary and/or secondary field values.

In addition, the composition module 100 may include a web portal or a mobile application for selecting and defining the containers, contents and interactions between these elements through a succession of clicks by the author(s). The technologies used are preferably selected from: PHP, JavaScript, HTML and CSS.

The configuration file or set of configuration files 300 according to the invention comprises at least one scene 310, at least one navigation node 320, and at least one media node 330. This file or set of configuration files 300 corresponds to a particularly advantageous aspect of the invention. Indeed, it is at least in part the existence of this file or set of files 300 that will allow the system 1 according to the invention to provide the author with the possibility of creating or modifying quickly, and without programming knowledge, the virtual reality experience sequence 10.

Moreover, this type of file has an architecture which is divided into three main parts: scenes, navigation nodes, media nodes. This allows the composition module 100 to quickly access to the desired information.

Similarly, the recording of this information in the form of a file or set of independent configuration files 300 makes it possible to preserve a stable composition module 100, comprising in particular a recording application 111 that is not necessary to modify for composing or modifying a virtual reality experience sequence. This has the advantage, on the one hand, to control the development costs and, on the other hand, to produce new sequences in the absence of programming knowledge.

As mentioned above and as shown in FIG. 2, the file or set of files 300 comprises at least one scene 310 characterized by primary scene fields 311.

The primary scene fields 311 comprise a unique identifier 312 of said scene. This unique identifier 312 will be assigned only for a single scene and may be for example a sequence of letters and numbers or a combination of letters and numbers. Thus, it will allow identifying a scene with certainty.

The primary scene fields 311 also comprise access 313 to an environment media file 361 representing a place 20. It is this environment media file 361 that will serve as a basis for the display module 200, via a reading module 600, for the representation of the view. The environment media file 361 may for example be jpeg.

These primary scene fields 311 are associated with data elements 400 that define the value of these primary scene fields 311. The composition module 100 is able, via the recording device, to generate or modify the configuration file(s) 300 and to modify the data elements 400 associated with these fields.

The scene 310 may be characterized by other fields, called secondary fields that may detail the characteristics of said scene. For example, secondary fields may be selected from elements constituting the metadata describing said characteristic.

As shown in FIG. 2, the file or set of files 300 comprises at least one navigation node 320 characterized by primary navigation fields 321.

The primary navigation fields 321 comprise a unique identifier of a departure scene 322, a unique identifier of an arrival scene 323, a position of the navigation node 324 in the place of the departure scene according to a spherical coordinate system (O, x, y, z) and a transition rule 325.

The unique identifier of a departure scene 322 makes it possible to define the position of the representation of the navigation node 320 in a place 20 within the virtual reality experience sequence 10. This position is then detailed by the primary field: “position of the navigation node in the place of the departure scene according to a spherical coordinate system (O, x, y, z) 324” which makes it possible to accurately position the representation of the navigation node in the departure place. The spherical coordinate system can be positioned as shown in FIG. 6 where it has a value z=0 because the place is not a three-dimensional modeling but a panoramic photo. The position of the navigation node in the place of the departure scene is expressed in spherical coordinates, which makes it possible to accurately position the representation of the navigation node in the departure place, around the point of view of the user. The unique identifier of an arrival scene 323 allows a composition module 100 or a reading module 600 to determine the action that will be performed when the navigation node 320 will be actuated, that is to say the arrival place 22 that will replace the departure place 21.

The transition between the departure place 21 and the arrival place 22 is managed by a transition rule 325. This primary navigation field, “transition rule 325”, makes it possible to define the transition visual 325 which will be experienced by the user. The value of this transition rule, as defined by the data elements 400, can be selected from a section, a fade, a flap, a curtain, an animated transition or a transition including the playback of a video. Preferably, at least one transition rule includes a data element of the “transition media File” type. Indeed, when using a transition media file 363, the passage from the departure scene to the arrival scene may include a video sequence and/or a sound sequence and thus behave as a media transition 40. Thus, advantageously, the connection between two places 20 may comprise a transition rule 40 associated with a transition media content 363 as schematized in FIG. 1.

The navigation node(s) 320 according to the invention may also include at least one secondary navigation field 326. These secondary fields can detail the characteristics of the navigation node 320. For example, secondary fields may be selected from:
a unique identifier of the navigation node 327, such as the unique scene identifier, this unique identifier enables the composition module 100 to quickly identify a navigation node 320 within the configuration file(s) 300 of the virtual reality experience sequence 10,
a text 328, which can give information on the navigation node 320 or on the arrival view and that can be displayed in relation to the navigation node, and
a means for access to data on the arrival view 329.

The media node 330 is characterized by primary media fields 331. The primary media fields 331 comprise a unique identifier of the scene on which the media node 332 depends, a position of the media node in the place of the scene comprising the media node according to a spherical coordinate system (O, x, y, z) 333, an access path 334 to a content media file 362 and a control rule 335.

Generally, the media node 330 can provide access to an image, a soundtrack or a video. Nevertheless, the media node 330 may also provide, thanks to the primary control rule field 335, access, in a single action, to a plurality of media such as a slide show or a content grid. Thus, the data element 400 of the rule 335 for the control of at least one media node 330 is selected from a slide show or a content grid.

The media node(s) 330 according to the invention may also include at least one secondary navigation field 336. These secondary fields can detail the characteristics of the navigation node. For example, secondary media fields 336 may be selected from:
a unique identifier of the media node 337,
a distance value 338 for modifying the display of the content media and thus creating an impression of depth, and
a value for controlling time elapsing before execution of the media 339.

In addition to being easily modifiable, the system according to the invention is preferably lightweight to allow a fast transfer and a use on a wide variety of devices, preferably mobile devices. Thanks to the architecture of the system 1 proposed by the inventors including a file or set of files 300, a composition module 100 and a media device 350, it is possible to reduce the size allocated to the configuration file(s) 300.

Thus, advantageously, the file or set of files 300 may have a size less than 200 or 100 kilobytes, preferably less than 50 KB, even more preferably less than 30 KB. When the invention includes a set of configuration files and not a unique configuration file, then the size above corresponds to the sum of the size of the configuration files forming the set 300.

Preferably, the system 1 comprises a set of configuration files and not a unique configuration file. Indeed, the presence of several configuration files further increases the modularity of the virtual reality experience sequence according to the invention. In addition, this gives the possibility to work in parallel on several different aspects of the sequences (scene, media node . . . ) or to work in parallel on several subsets of places whose characteristics are recorded in different configuration files.

Advantageously, the set of files may comprise at least one configuration file called “organizer” configuration file 370 comprising a list of the set of configuration files required for the customization of the virtual reality experience. The system is able to load, from this file, the information for accessing the file(s) required for the virtual reality experience sequence 10. Thus, the unique structure of the system 1 for composing or modifying the virtual reality experience sequence 10 according to the invention enables to easily add experiences complementary to the existing sequence, for that, it is enough to create one or more configuration file(s) dedicated to the subsequence to be added and to modify the configuration file called organizer configuration file 370. The present invention thus provides the possibility to improve the visit and redefine the proposed interaction rules for the navigation and the consultation of the media.

The set of configuration files 300 can also be cut as follows:
a configuration file called organizer configuration file 370,
a configuration file called scene configuration file, comprising the scenes, the navigation nodes as well as for the media nodes 330, the fields of unique identifier of the media node 337, of unique identifier of the scene on which the media node 332 depends, and of position of the media node in the place of the scene comprising the media node according to a spherical coordinate system (O, x, y, z) 333,
a configuration file called media configuration file, comprising the fields related to the access path 334 to a content media file 362, to a control rule 335, to a unique identifier of the media node 337, to a distance value 338, and to a value defining the execution of the media 339.

The existence in the set of configuration files 300 of a configuration file called scene configuration file, including all the information on the places 20 and in particular on the positions of the nodes present in these places 20 coupled to a configuration file defining the media information, makes it possible to propose an easier solution for the modification of the media within a structure of places that remains unchanged.

The file or set of configuration files 300 may be encoded into a large number of programming languages. Preferably, it is encoded in Extensible Markup Language.

The system 1 also comprises a device 350 including media files 360. The media files 360 may for example be images, videos, sound tracks or slide shows.

Preferably, the media files 360 are collected within the same folder, this folder may comprise subfolders.

Preferably, the file or set of configuration files 300 and the device 350 are located on the same device that can be for example a mobile device, a server or a computer.

The primary fields 311, 321, 331, previously described, can be associated with data elements 400 that define the value of these primary fields 311, 321, 331. These data elements 400 are generally sequences of letters and/or numbers that may include symbols and which are processed by the composition module 100.

The composition module 100 of the virtual reality experience sequence 10 comprises a recording device 110 provided with rules enabling it to record, in the configuration file or set of configuration files 300, the data elements 400 and to have access thereto.

Thus, during the composition or modification of the virtual reality experience sequences 10, the composition module 100 via the recording device 110 connects to the configuration file(s) 300 and modifies the data elements 400 associated with the primary and/or secondary fields. It is also configured to record the data elements 400 in the configuration file or set of configuration files 300. These data elements 400 at least partially define the virtual reality experience sequence 10. The latter being mainly defined by the data elements 400 and the media files. These data elements 400, recorded in the configuration file or set of configuration files 300 and associated with the primary fields will allow the composition module and the reading module to transfer to the display module, the information required for the display of the virtual reality experience sequence and in particular media files composing this virtual experience sequence.

FIG. 3 presents a simplified schematic view of a composition system according to the invention subdivided into three main parts: a device 5 including most of the composition system 1 that can be hosted on a site for example in the premises of a company, a device 6 dedicated to the interaction between the system 1 and an author; a system 7 dedicated to the reading of the new virtual reality experience sequence 10 created by the author.

Specifically, the composition module 100 may comprise a recording device 110 located on the same device as the file or set of configuration files 300 and a control device 120 that can receive instructions from an author and transfer them via a network to the recording device 110. This arrangement allows the invention to provide a solution for the parameterization of a virtual reality visit experience in the form of a SAAS service.

For example, the composition module 100 may comprise an application installed on a mobile device (e.g. laptop computer, mobile phone, tablet, virtual reality headset), on a computer or on a server. The application can be installed on a phone via an APK type file or on a PC computer via an executable-type file. The control device 120 may also, according to the instructions of the author, transfer media files from a media device 352, integrated with the device 6, to the device 5. These media files may for example be images, videos, sound tracks or slide shows.

The composition or modification system 1 according to the invention may also comprise a display module 202, integrated with the device 6, able to receive and display information from the module 100 for composing the virtual reality experience. The display module 202 makes it possible to display a creation interface and/or the virtual reality experience sequence. The display module 202 may include a VR headset, a tablet or a desktop screen and an executable application configured to present a creation interface and/or the virtual reality experience sequence to the author. The creation interface, in combination with the control interface 120, allows the author to select the data elements for the primary and secondary fields.

Specifically, the composition module 100 may not be associated with the same device as the file or set of configuration files 300 or as the media device 350. For example, the composition module 100 may be associated with a mobile device while the configuration files 300 are recorded on a remote server.

The device 7 is for example a remote place, such as a server portion, a mobile device or a virtual reality headset, dedicated to the implementation of the virtual reality experience sequence 20 under modification or creation. It may include a configuration file or set of configuration files 303 dedicated to said sequence 20, a display module 203 specific to the device 7 and a storage device 353 including media files.

According to another aspect, the invention relates to a method 2 for composing or modifying a virtual reality experience sequence 10. This composition method allows a non-specialist to define all the elements of the visit (places, navigation links, searchable media and their positioning in each place) in an interface with which it is possible to interact without programming knowledge. That is to say, the user only needs to select the form of the virtual reality experience sequence for example via an internet portal or a dedicated mobile application in a wysiwyg approach (“what you see is what you get”). The composition system according to the invention will support the construction of the files enabling the composition of this sequence. It is also possible, thanks to this method, to append to an initial sequence, contents of all types and without programming knowledge.

FIG. 4 presents the steps of the method 2 for composing or modifying a virtual reality experience sequence 10 according to the invention.

The method for composing or modifying 2 a virtual reality experience sequence according to the invention can be implemented by the system described above or by any other suitable system. A suitable system will comprise, for example, a module 100 for composing a virtual reality experience sequence including a control device 120 capable of interacting with an author, a file or set of configuration files 300, a media file device 350. Preferably, the method 2 for composing or modifying a virtual reality experience sequence 10 according to the invention is implemented by the system 1 described above.

The method comprises the following steps:
a step 510 of creating a connection (511 in FIG. 3) between a control device 120 capable of interacting with an author and a recording device 110,
a step 520 of accessing, by the recording device 110, to the file or set of configuration files 300,
a step 530 of displaying, by a display module 202, a creation interface configured to receive and display information from the module 100 for composing the virtual reality experience sequence 10,
a step 540 of transmitting, to the recording device 110, by the control device 120, at least one data element 400 associated with a primary scene 311, navigation 321 and/or media 331 marker, the data element 400 associated with a primary marker 311, 321, 331 enabling to at least partially define the virtual reality experience sequence, and
a step 550 of recording said data element 400 in the file or set of configuration files 300, by the device 110 for recording the virtual reality experience sequence 10.

During this method, for example at the request of the author, a connection will be established between a recording device 110 and a control device 120. The author may interact with the control device 120 so to access via the recording device 110 to the configuration file(s) 300. The control 120 and recording 110 devices are part of the composition module 100 described above.

Via a display module 200 or 202 accessible to the author, the author can select at least one data element 400 which will be then transmitted to the recording device 110, by the control device 120. This selection can be performed by a graphic application comprised in the display module 200, 202. This display module 200, 202, control device 120, recording device 110 set enables the author to choose the data elements 400 associated with several fields of the sequence such as environment, content and transition media files. Thus, the author has the possibility to modify the views as well as the accessible contents when using the virtual reality experience sequence. But these choices can be implemented without programming knowledge. They are for example made possible by drop-down choice lists displayed by the display module 200, 202, or windows for selecting media files to include.

The author can also select data elements 400 corresponding to the values of the other primary and secondary fields as described above. These data elements are transmitted to the recording device 110 by the control device 120. The file or set of configuration files 300 described in this part corresponds to the file or set of configuration files 300 described above.

For example, it is possible for the author to select via the display module different transition elements (e.g. 2D, 3D scenes, 360 2D, 3D video, sounds, fixed 2D contents, multimedia streams . . . ) which will be then implemented in the sequence. Thus, the control device will access to the selected transition media files and then transmit them to the recording device 110 which will record them with the other media files. Similarly, the media files associated with the sequence can come from several sources. In a particular step, all the media files 360 are recorded in the media device 350. Preferably, these centralized media files can then be transferred to the users.

Preferably, during the composition method according to the invention, the recording device 110 processes firstly the scenes and/or the navigation nodes and secondly the media nodes. Specifically, the files encoding the applications implemented within the composition module 100 are not modified when composing or modifying the virtual reality experience.

Specifically, the control device 120 can access to media files 361 being contained on the device 6 of the author. These media files can be transferred by the control device 120 to the recording device 110 so as to record them for example on a server 5. In another step, when the virtual reality experience sequence has been modified, the recording device 110 can collect all the media files used during the virtual reality experience sequence and record them for example on a mobile device 7 or a plurality of mobile devices. Thus, the method may further comprise a step 560 of recording, on a mobile device 7, organized media files 363 and/or modified configuration files 303.

Specifically, the author can customize the repeatability of an action connected to a media node.

Specifically, this method may also comprise a step of sending the virtual reality experience sequence 10 in the form of a file or set of configuration files 300 and the set of the media 360 required on a mobile device 7. The mobile device 7 being preferably a tablet, a touch screen phone or a virtual reality headset.

In this case, advantageously, the composition method 2 of a virtual reality experience sequence 10 will comprise a step of verifying the obtained virtual reality experience sequence.

Preferably, the verification step 570 of the virtual reality experience sequence 10 comprises a step of displaying the virtual reality sequence 10. This optional display can be done either in an immersive manner 571, that is, the display module will display the content of the sequence for example as if the user was navigating in the virtual reality experience sequence; or in a synoptic manner 572, that is to say, the display module will display a dependency graph representing the organization of the sequence for example as shown in FIG. 1.

In the case where the display of the sequence is done in an immersive manner then, preferably, all the navigation and media nodes will be displayed within the view. Preferably, these two types of nodes will be represented in a different way in order to allow the author to quickly differentiate them. For example, the navigation nodes may be represented by stars (see FIG. 7) while the media nodes may be represented by circles (see FIG. 7). This form of display has the advantage of allowing the author to quickly create or delete navigation and/or media nodes or to modify the values of their primary and/or secondary fields such as the position field.

In addition, in this case, the representation of the nodes may be accompanied by the representation of the values of the primary fields or of the primary and secondary fields of these nodes.

In the case where the display of the sequence is made in a synoptic manner, then this representation can take a form similar to that of FIG. 1; the author can thus click on the various elements of the representation so as to bring up dialog boxes giving him the possibility to modify the values of the primary and/or secondary fields. This form of display has the advantage of enabling to quickly view the extent of the experience sequence and to make changes in the navigation nodes.

Advantageously, during the composition or modification method, the coordinates of the mouse according to the spherical coordinate system (O, x, y, z) of the view are permanently displayed by the display module. This allows positioning the nodes more easily.

The unique identifier of the nodes can also be displayed permanently. Furthermore, the media nodes having no associated media are not represented in the same way as the media nodes having at least one associated media. This can also be applied so as to differentiate the navigation nodes that are or are not connected to an arrival scene. For example, a media node that does not have an associated media file can be displayed in green with its identifier. Thus, preferably, during the display of the virtual reality experience sequence 10, the composition module is able to identify the navigation nodes 320 or the media nodes whose primary fields do not include associated data elements 400.

According to another aspect, the invention relates to a system 3 for reading the virtual reality experience sequence 10. This reading system 3 is based on the use of a file or set of configuration files 300 as described above. It proposes a lightweight solution quickly transferable to a set of users and not requiring too significant resources for the mobile display device.

FIG. 5 presents a system 3 for reading a virtual reality experience sequence according to the invention.

The system 3 for reading a virtual reality experience sequence 10 according to the invention can be implemented with a virtual reality experience sequence as obtained by the composition or modification method described above or with any other suitable sequence. The suitable sequence will be for example based on the presence of a file or set of configuration files 300 and of a device 350 comprising media files 360 as described above. Preferably, the system 3 for reading a virtual reality experience sequence according to the invention is implemented on a virtual reality experience sequence as obtained by the composition or modification method described above.

The reading system 3 comprises:
a module 600 for reading a virtual reality experience sequence 10,
a module for displaying on a mobile device 203,
a configuration file or set of configuration files 300, and
a device 350 including a set of media files 360.

The configuration file or set of configuration files 300 as well as the device 350 including a set of media files 360 have already been described above and their particular and preferred characteristics described above are also applicable to the reading system 3 according to the invention.

The module 600 for reading the virtual reality experience sequence 10 comprising a means 610 for access to data elements 400, a device 620 for acquiring and processing the data elements 400 and a module 630 for transmission to the display module 200. The transmission module 630 being configured to transmit to the display module 200 the virtual reality experience sequence 10 such that it can be viewed by one or more user(s).

Specifically, this system may comprise a user identification module 150 of the system 3 for reading the virtual reality experience sequence 10. It enables in particular a multiuser reading of the virtual reality experience sequence.

Specifically, this system comprises a module for broadcasting on a mobile device the virtual reality experience sequence.

Specifically, the reading module 600 comprises an application installed on a mobile device.

The reading module 600 may comprise an application installed on a mobile device in the exe, apk, or ipa format.

Specifically, the display module is able not to display the media nodes in case of absence of associated media file.

From the point of view of the user (e.g. visitor), the available actions are represented by floating visual elements in the place he is visiting. These visual elements are dynamically placed in the place, based on the file or set of configuration files 300. The visual elements may have a different visual representation depending on the action or content they represent, as well as a contextual help text. When his gaze approaches a node, a cursor appears to help him to fix the point in question accurately. As soon as his gaze is in proximity to the point, a time indicator appears near the pellet to show the user the imminence of the triggering of the action. The user chooses his action by fixing for a determined time the appropriate point of interest. The action is triggered automatically as soon as the determined time has elapsed, since the user did not look away. A customizable textual and/or audio content is associated with the point to provide point related information. To see this text, there is no need to target the point directly, as this would trigger playback, but an area invisible to the user around the point defines a surface in which the viewfinder of the gaze is displayed, triggers the display of the point of interest and displays the text.

Preferably, the display module 203 is able to display at least one recommended route. In the absence of a user guide, this allows a user to follow indications appearing on his field of view and thus to be able to follow a virtual reality experience sequence in an optimized manner.

In addition, specifically, the display module 203 is able not to display the media nodes in case of absence of associated media file.

The current methods for navigation within virtual reality sequences is based on the presence of a pointer represented on a display screen and corresponding to the position of the user's gaze within the field of view. The user can direct his gaze so as to modify the display and approach navigation elements visible on the display screen, and then he can activate them. Starting from the analysis of the existing navigation methods and devices and the existing problems, the inventors have developed a new navigation device in virtual reality experience sequences and a new associated method.

In the virtual reality experience sequences, the immersion and the interaction are two paradigms to be optimized in order to allow one or more individual(s) to interact with a virtual mode through an interface giving him the illusion of reality. In order to reinforce the immersive potential of a virtual reality experience sequence, the inventors have developed a new device and an associated method so that the position of the user's gaze is not systematically represented on the display screen. Similarly, the objects with which the user can interact are not systematically represented on the display screen.

According to this new method, the pointer representing the position of the user's gaze is visible only when he is close to an object with which the user can interact. Specifically, the pointer appears on the display screen only when the pointer is at a distance from the nearest object representing less than 10%, preferably less than 5% of the length of the field of view. According to another embodiment, the pointer appears on the display screen only when the pointer is at a distance from the nearest object representing less than 10%, preferably less than 5% of the length of the display screen.

FIG. 7 represents an embodiment of this aspect of the invention. The gray background indicates the field of view 710. The field of view comprises a visible navigation node 721 and a visible media node 731. The pointer 740 becomes a visible pointer 741 only when approaching an interaction point such as a visible navigation node 721 or a visible media node 731.

In another embodiment, the field of view comprises a non-visible navigation node 720 and a non-visible media node 730. As previously, the pointer 740 becomes a visible pointer 741 only when approaching an interaction point such as a non-visible navigation node 720 or a non-visible media node 730. Similarly, the non-visible navigation node 720 and the non-visible media node 730 become visible nodes 721, 731 when the pointer 740 approaches.

Advantageously, when the pointer 740 approaches, a text on the content of the node is displayed. This text may for example correspond to the data element 400 associated with the secondary field 328.

Advantageously, when the pointer is close to a node (e.g., at a distance corresponding to the appearance of the node), a counter is displayed. The counter can take different forms such as for example a digital countdown, a pointer running through a dial or a dial fading around a point. Indeed, when the node appears, it is said booted and if the user keeps his gaze at a sufficient distance from the node for it to remain visible then, after a time required for activation and that can be configured, the node is activated and the action associated with the node is performed. For example, the time required for activation can be of 1 second, 2 seconds, 3 seconds, 4 seconds or 5 seconds.

Advantageously, when the pointer is close to a node (e.g. at a distance corresponding to the appearance of the node), the display module is configured to bring up an activation shape 750 allowing to view the area allowing the appearance of the node or its maintenance. This shape may be for example ellipsoidal (e.g. circular, such a pellet), square, rectangular. Preferably this shape is ellipsoidal and more particularly square. Specifically, this shape can also mach the shape of the element of the view associated with the node. For example, if a navigation node is positioned in a view at the representation of a door, then the activation shape 750 substantially matches the shape of the door in the view.

1. A system for composing or modifying a virtual reality experience sequence, said virtual reality experience sequence comprising, on the one hand, a plurality of places connected together, a connection between two places being operated by a navigation node and, on the other hand, media contents connected to the places, a connection between a place and a media content being operated by media nodes, said system comprising:
a module for composing a virtual reality experience sequence,
a configuration file or set of configuration files comprising:
at least one scene characterized by primary scene fields, said primary scene fields comprising a unique identifier of said scene and means for access to an environment media file representing a place,
at least one navigation node characterized by primary navigation fields, said primary navigation fields comprising a unique identifier of a departure scene, a unique identifier of an arrival scene, a position of the at least one navigation node in the place of the departure scene according to a spherical coordinate system and a transition rule,
at least one media node characterized by primary media fields, said primary media fields comprising a unique identifier of the scene on which the media node depends, a position of the media node in the place of the scene comprising the media node according to a spherical coordinate system, an access path to a content media file and a control rule, and
a device including media files,
said primary scene fields, said primary navigation fields and said primary media fields all being associated with data elements defining a value of these primary fields, said module for composing the virtual reality experience sequence comprising a recording device equipped with rules enabling it to record the data elements in the configuration file or set of configuration files,
said data elements defining at least partially the composed or modified virtual reality experience sequence.

2. The system according to claim 1, further comprising a display module.

3. The system according to claim 1, wherein the places are representations of real places by 360 or 360 stereo 2D, 3D panoramic images.

4. The system according to claim 1, wherein each said place is represented by 360 stereo images.

5. The system according to claim 1, wherein the navigation node(s) is/are further characterized by at least one secondary navigation field selected from:
a unique identifier of the navigation node,
a text, giving information on the navigation node, and
a means for access to data on an arrival view.

6. The system according to claim 1 wherein the media node(s) is/are further characterized by at least one secondary media field selected from:
a unique identifier of the media node,
a distance value, and
a value for controlling time elapsing before execution of media.

7. The system according to claim 1, wherein the media contents are selected from: photos, slide shows, videos, sound elements.

8. The system according to claim 1, wherein the virtual reality experience sequence is representative of a real place and can be compared to a visit.

9. The system according to claim 1 wherein the data element of the rule for the control of the at least one media node is selected from a slide show or a content grid, said slide show or said content grid enabling access to a plurality of media into a single action.

10. The system according to claim 1 wherein the data element of the rule for transition of the at least one navigation node is selected from a section, a fade, a flap, a curtain, an animated transition or a transition including the playback of a video.

11. The system according to claim 1 wherein the configuration file(s) has/have a size less than 200 kilobytes.

12. The system according to claim 1, further comprising a set of configuration files at least one of which is an organizer configuration file comprising a list of the set of the configuration files required for the customization of the virtual reality experience sequence.

13. The system according to claim 1, further comprising a set of configuration files including:
a configuration file called organizer configuration file,
a configuration file called scene configuration file, comprising the scenes, the navigation nodes as well as for the media nodes, the fields of unique identifier of the media node, of unique identifier of the scene on which the media node depends, and of position of the media node in the place of the scene comprising the media node according to a spherical coordinate system,
a configuration file called media configuration file, comprising the fields related to the access path to a content media file, to a control rule, to a unique identifier of the media node, to a distance value, and to a value defining the execution of the media.

14. The system according to claim 1, wherein the unique identifier of a departure scene makes it possible to define the position of the representation of the navigation node in a place within the virtual reality experience sequence.

15. A method for composing or modifying a virtual reality experience sequence implemented by the system according to claim 1, said virtual reality experience sequence comprising, on the one hand, places connected together, a connection between two places being operated by a navigation node and, on the other hand, media contents connected to the places, a connection between a place and a media content being operated by media nodes, said method comprising:
creating a connection, in a module for composing a virtual reality experience sequence, between a control device capable of interacting with an author and a recording device,
loading, by the recording device, a file or set of configuration files, said file or set of configuration files comprising:
at least one scene characterized by primary scene fields, said primary scene fields comprising a unique identifier of said at least one scene and means for access to an environment media file representing a place,
at least one navigation node characterized by primary navigation fields, said primary navigation fields comprising a unique identifier of a departure scene, a unique identifier of an arrival scene, a position of the navigation node in the place of the departure scene according to a spherical coordinate system and a transition rule, and
at least one media node characterized by primary media fields, said primary media fields comprising a unique identifier of the scene on which the media node depends, a position of the media node in the place of the scene comprising the media node according to a spherical coordinate system, an access path to a content media file and a control rule,
said primary fields can be associated with data elements defining the value of said primary scene fields, said primary navigation fields and said primary media fields,
displaying, by a display module, a creation interface configured to receive and display information from the module for composing the virtual reality experience sequence,
creating, by the device for recording the virtual reality experience sequence, at least one data element associated with a primary scene marker, a primary navigation marker and/or a primary media marker, the data element associated with a said primary scene marker, said primary navigation marker and/or said primary media marker allowing to at least partially define the virtual reality experience sequence, and
recording said data element in the file or set of configuration files, by the recording device.

16. A system for reading a virtual reality experience that can be obtained by the method according to claim 15, comprising a device for displaying a virtual reality experience, said virtual reality experience comprising, on the one hand, places connected together, a connection between two places being operated by a navigation node and, on the other hand, media contents connected to the places, a connection between a place and a media content being operated by media nodes, said device comprising:
a module for reading a virtual reality experience,
a display module,
a configuration file or set of configuration files comprising:
at least one scene characterized by primary scene fields, said primary scene fields comprising a unique identifier of said at least one scene and means for access to an environment media file representing a place,
at least one navigation node characterized by primary navigation fields, said primary navigation fields comprising a unique identifier of a departure scene, a unique identifier of an arrival scene, a position of the navigation node in the place of the departure scene according to a spherical coordinate system and a transition rule, and
at least one media node characterized by primary media fields, said primary media fields comprising a unique identifier of the scene on which the media node depends, a position of the media node in the place of the scene comprising the media node according to a spherical coordinate system, an access path to a content media file and a control rule, and
a device including a set of media files,
said primary scene fields, said primary navigation fields and said primary media fields being associated with data elements defining the value of these primary fields,
said module for reading the virtual reality experience sequence comprising a means for access to the data elements, a device for acquiring and processing the data elements and a module for transmission to the module for displaying the virtual reality experience sequence.

17. The system according to claim 16, further comprising a user identification module of the system for reading the virtual reality experience sequence capable of authorizing the multi-user reading of the virtual reality experience sequence.

18. The system according to claim 16, configured such that actions, available to users of the system, are represented by floating visual elements in a place that the user is visiting, said visual elements being placed in the place, based on the information contained the file or set of configuration files.

19. The system according to claim 16, configured such that, when a user's gaze is close to a node, a cursor appears to help said user to fix the point in question accurately.

20. The system according to claim 16, configured such that a pointer representing a position of a user's gaze is visible only when the pointer is at a distance from a nearest object representing less than 10% of a length of the field of view.

21. The system according to claim 16, configured such that, when a user's gaze is close to a node, a time indicator appears to indicate to the user the imminence of triggering of an action.

22. The system according to claim 16, further comprising a module for displaying on a mobile device, said display module being able to display at least one recommended route.
